(19) United States
(12) Patent Application Publication
(10) Pub. No.: US 2023/0253914 A1
(43) Pub. Date: Aug. 10, 2023

(54) SOLAR CELL ROOF

(71) Applicant: Emera Technologies LLC, Tampa, FL (US)

(72) Inventors: Anthony Ruffine, Arlington, VA (US); Kurt Dammermann, Bryn Mawr, PA (US); Christopher Marks, Philadelphia, PA (US); Jason Zerweck, Media, PA (US); Patrick Sweeney, Elkins Park, PA (US); Kenneth Carter James, Baltimore, MD (US); Michael Barretta, Philadelphia, PA (US)

(21) Appl. No.: 18/301,049

(22) Filed: Apr. 14, 2023

Related U.S. Application Data
(63) Continuation of application No. PCT/US2021/054758, filed on Oct. 13, 2021.
(60) Provisional application No. 63/092,245, filed on Oct. 15, 2020.

(51) Int. Cl. H02S 20/25; E04D 3/36; E04D 3/365; E04D 13/17

(52) U.S. Cl. CPC H02S 20/25; E04D 3/3606; E04D 3/365; E04D 13/17

(57) ABSTRACT

A solar roof of a building includes a plurality of solar panels removably coupled to a roof of the building such that a first solar panel of the plurality of solar panels is configured to be removed from the roof without removing an adjacent solar panel.

### CROSS-REFERENCE TO RELATED APPLICATIONS

This application is a continuation of International Patent Application No. PCT/US2021/054758, titled “Solar Cell Roof”, filed on Oct. 13, 2021, which claims priority to and the benefit of U.S. Provisional Patent Application No. 63/092,245, titled “Solar Cell Roof”, filed on Oct. 15, 2020, and the specification and claims thereof are incorporated herein by reference.

### BACKGROUND OF THE INVENTION

### Field of the Invention

The current disclosure relates to roofing systems and more particularly to solar cell roofing systems and methods of fabricating or constructing a roof using such roofing systems.

Solar roofs, or photovoltaic roofs, are roofs that provide aesthetic and weatherproofing functions of conventional roofs, while generating electricity from sunlight. In a solar roof, solar panels (also referred to as solar cell panels, solar/power shingles, photovoltaic panels/shingles, etc.), can resemble the appearance of conventional roofing materials (e.g., asphalt, slate, etc.) are attached to the roof of a building to collect and produce electricity from sunlight. Technically called building-integrated photovoltaics (BIPV), solar roofs present a unique and increasingly popular renewable energy solution. Studies backed by the U.S. Department of Energy have shown that a solar roof can substantially increase the value of a home. Typically, to form a solar roof, solar panels are attached or bolted onto existing roofs with mounting brackets or other hardware. These types may not be efficient to install and/or operate because they are not well integrated into the structure of the building. They may also be hard to repair and/or replace. Typically, when a solar roof tries to match the aesthetics of conventional roofing materials, they reduce the electrical generation capabilities and generally add significant cost to the product. The solar cell roof of the current disclosure may alleviate some of the above-described deficiencies.

### BRIEF SUMMARY OF THE INVENTION

In one aspect, a solar roof of a building is disclosed. The solar roof includes a plurality of solar panels removably coupled to a roof of the building. Each solar panel of the plurality of solar panels includes solar cells. And any solar panel of the plurality of solar panels may be configured to be removed from the roof without removing an adjacent solar panel.

In another aspect, a method of forming a solar roof of a building is disclosed. The method may include removably coupling a first solar panel to a roof of the building, and removably coupling a second solar panel to the roof adjacent to the first solar panel. The first and second solar panels include solar cells. And the first solar panel may be configured to be removed from the roof without removing the adjacent second solar panel.

### BRIEF DESCRIPTION OF THE SEVERAL VIEWS OF THE DRAWINGS

The present invention will hereinafter be described in conjunction with the following drawings, wherein like numerals denote like elements. For simplicity and clarity of illustration, the drawings or figures depict the general structure and/or manner of construction of the various embodiments. Descriptions and details of well-known features and techniques may be omitted to avoid obscuring other features. Features in the figures are not necessarily drawn to scale. The dimensions of some features may be exaggerated relative to other features to assist improve understanding of the example embodiments.

FIG. 1 illustrates an exemplary solar roof on a building.

FIGS. 2A and 2B are illustrations of an exemplary support structure of the solar roof of FIG. 1;

FIGS. 2C, 2D, 2E, 2F, 2G, 2H, 2I, 2J, 2K, and 2L are illustrations of exemplary accessories used with the solar roof of FIG. 1;

roof of FIG. 1;

FIGS. 3A, 3B, 3C, 3D, and 3E are illustrations of an exemplary solar panel of the solar

FIG. 4 is an illustration of an exemplary filler panel of the solar roof of FIG. 1;

FIG. 5 is an illustration of an exemplary ridge panel of the solar roof of FIG. 1;

FIGS. 6A, 6B, 6C, 6D, and 6E illustrate the attachment of the solar panels of FIGS. 3A, 3B, 3C, 3D, and 3E on the roof support structure in an exemplary embodiment;

FIGS. 7A, 7B, and 7C illustrate the attachment of the filler panel of FIG. 4 on the roof support structure in an exemplary embodiment;

FIGS. 8A, 8B, and 8C illustrate the attachment of the ridge panel of FIG. 5 on the roof support structure in an exemplary embodiment;

FIGS. 9A, 9B, and 9C illustrate the installation of exemplary support caps between adjacent panels of the solar roof of FIG. 1;

FIGS. 10A, and 10B illustrate the installation of an exemplary ridge cap on the solar roof of FIG. 1; and

FIG. 11 illustrates the installation of an exemplary edge cap on the solar roof of FIG. 1.

### DETAILED DESCRIPTION OF THE INVENTION

The following detailed description is merely illustrative in nature and is not intended to limit the embodiments of the current application and the uses of such embodiments. Any implementation described herein as exemplary is not necessarily to be construed as preferred or advantageous over other implementations. Relative terms, such as, “top,” “bottom,” “front,” “back,” etc. are used with reference to the figure being described and are used for distinguishing between similar elements. These relative terms so not necessarily describe a particular spatial order. The terms “comprise,” “include,” “have” and any variations thereof are used synonymously to denote non-exclusive inclusion. The term “exemplary” is used in the sense of “example,” rather than “ideal.” In the interest of conciseness, conventional techniques, structures, and principles known by those skilled in the art may not be described herein, including, for example, the operating principle, structure, and fabrication of solar cells and solar cell panels.

Throughout the description below, terms such as top end, top side, top edge, top portion, etc. of a component (such as, for example, a panel) are used to refer to the end (side, edge, portion, etc.) of the component located closer to the ridge of the roof, and terms such as bottom end, bottom side, bottom edge, bottom portion, etc. are used to refer to the end (side, edge, portion, etc.) of the component located closer to eaves of the roof. Similarly, terms such as outer surface, front surface, etc. are used to refer to the surface of the component facing the sky, and terms such as inner surface, back surface, etc. are used to refer to the surface of the component facing the inside of the building (i.e., opposite the outer surface).

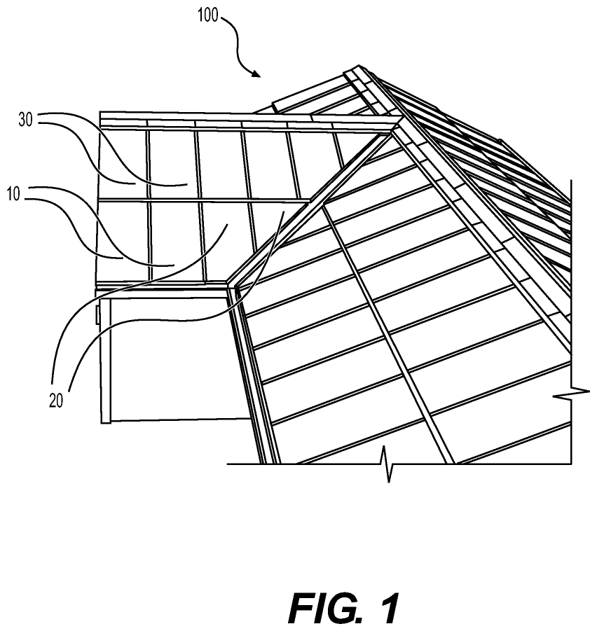

FIG. 1 illustrates a building with an exemplary solar roof 100. Solar roof 100 includes solar panels 10, filler panels 20, and ridge panels 30 arranged to form a roof structure. It should be noted that the relative size, number, and configuration of the different panels illustrated in FIG. 1 is only exemplary. In general, roof 100 may be formed of any number and configuration (e.g., shape, etc.) of solar, filler, and ridge panels 10, 20, 30. The structure of exemplary components of the solar roof 100, and an exemplary method forming the solar roof 100 on a building will now be described. In the description below, the solar roof 100 will be formed on a roof frame. However, a framed structure is not a requirement, and the solar roof may be formed on any suitable type of roof structure.

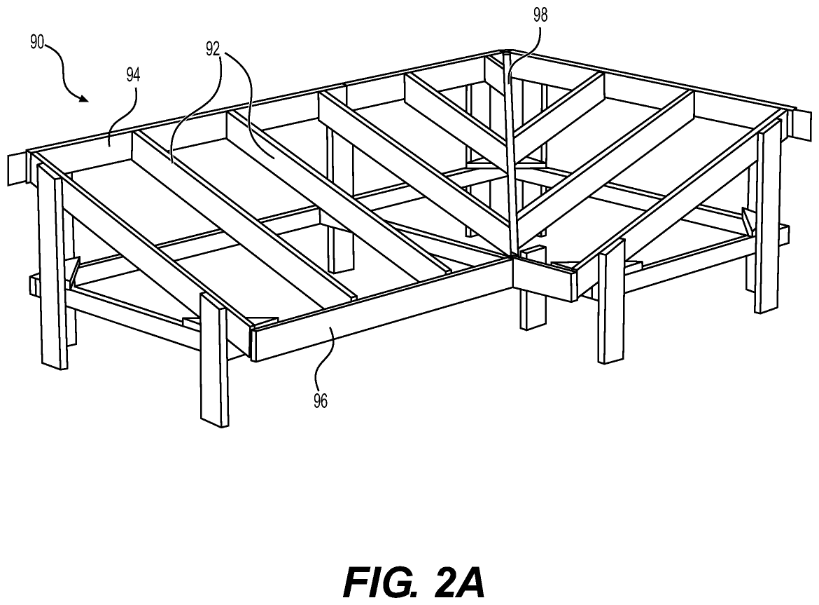

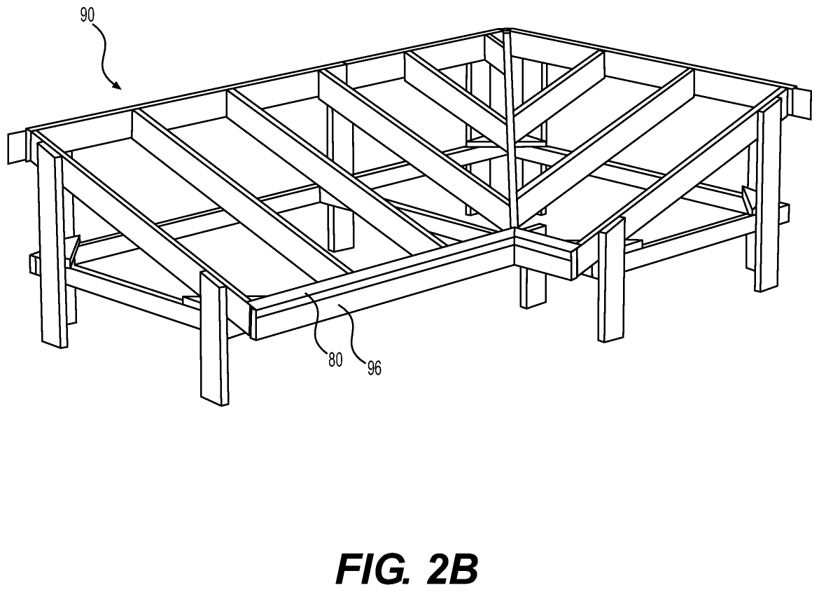

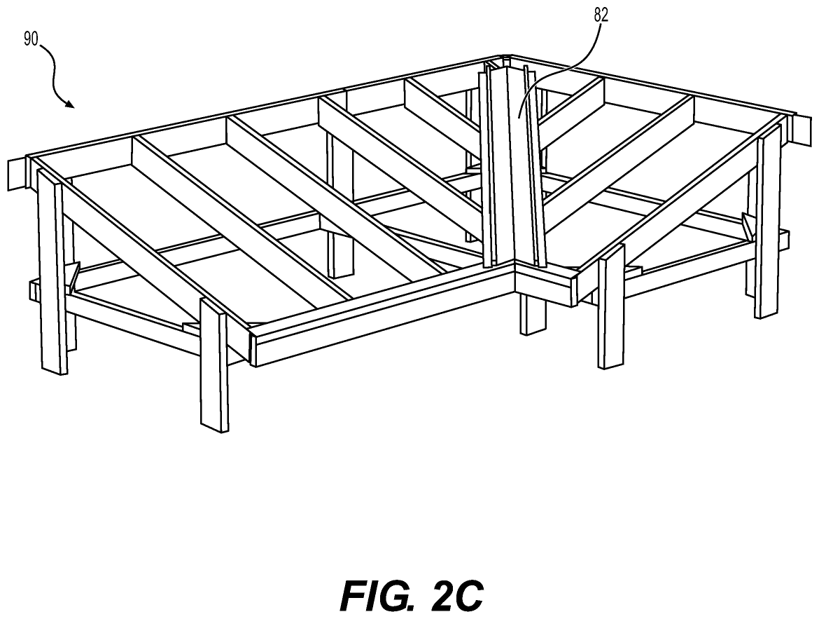

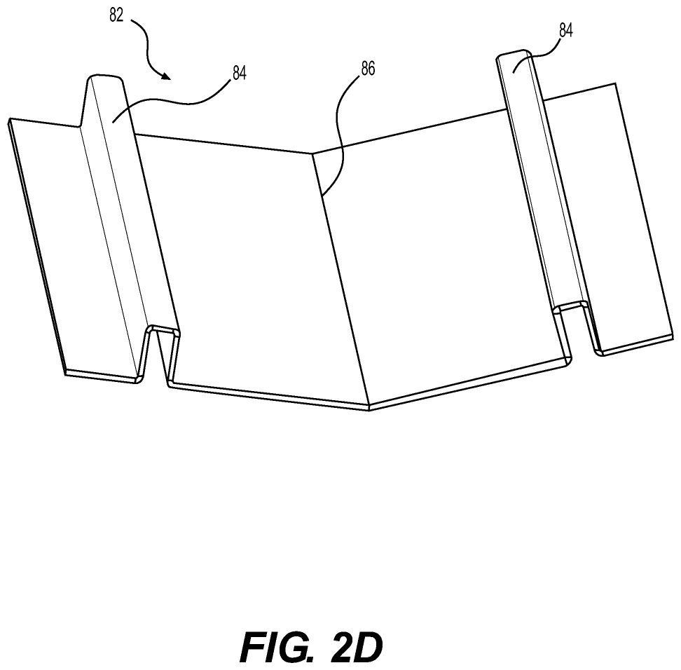

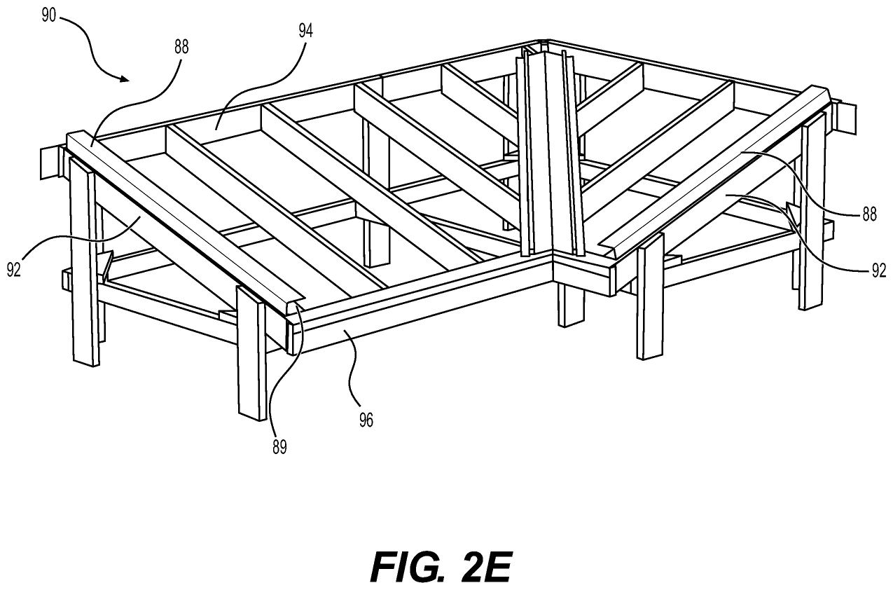

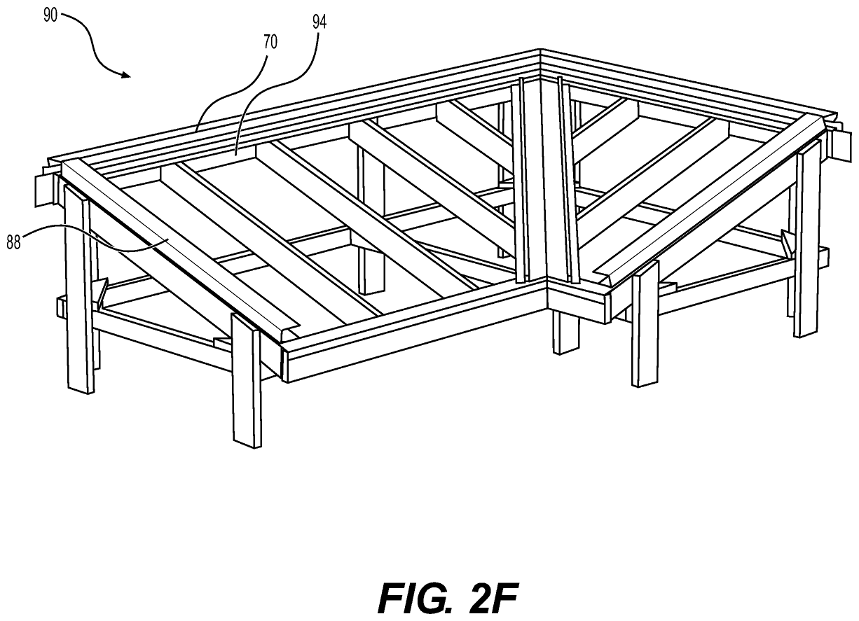

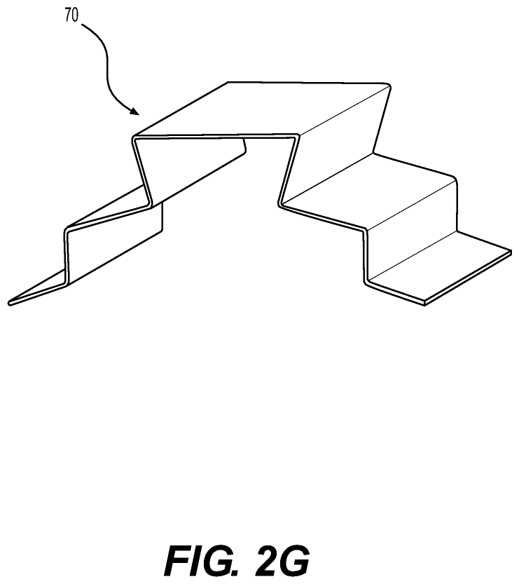

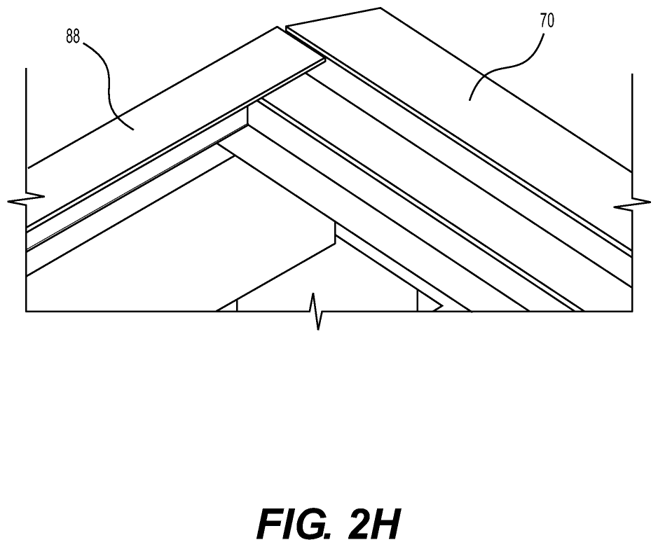

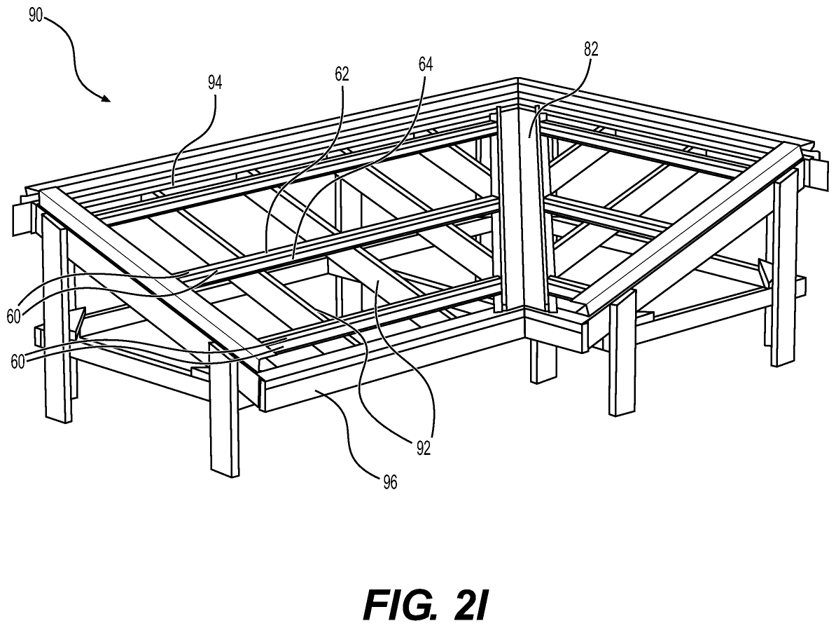

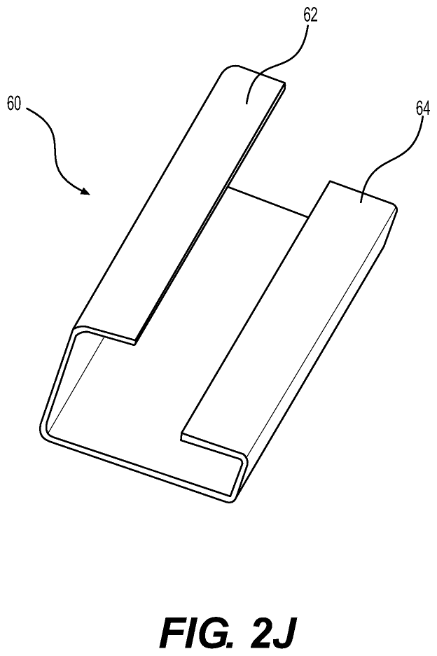

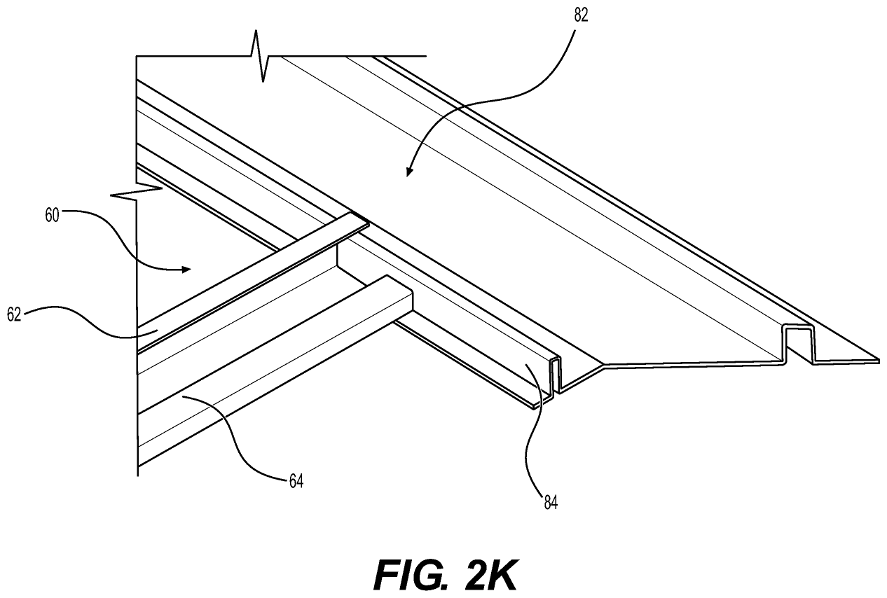

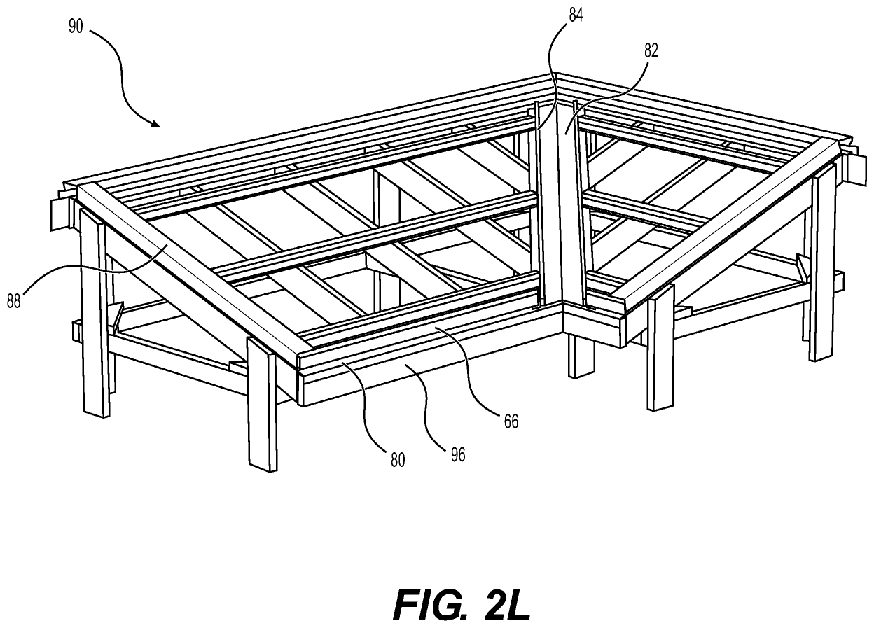

FIG. 2A illustrates a stand or a support structure (frame 90) of the solar roof. Frame 90, which is used to demonstrate the concept of the solar roof, resembles the frame of the building roof. The frame 90 includes multiple rafters 92 extending between a ridge beam 94 and a beam that forms the eaves 96. Ridge beam 94 is a structural member used to support the ends of the rafters 92 at the ridge or peak of the roof. The ridge beam 94 transfers its load to posts. Eaves 96 form the edges of the roof which overhang the face of a wall and, normally, project beyond the walls of a building to throw water clear of the building walls. A valley beam 98 is provided at the intersection of sections of the roof having different slope. Since the structure of frame 90 is well known to a person skilled in the art, it is not described in detail herein. In some embodiments, the rafters 92, ridge beam 94, eaves 96, and valley beam 98 may be made of timber. However, this is not a requirement, and in general, these components may be made of any material. In practice, the chosen material and structure may meet standard loading requirements and accommodate an approved mechanism for attaching the battens to the structure. In some cases, local building codes define the permissible spacing between and/or the size of the different components of frame 90. In some embodiments, the spacing between the rafters 92 may be 24″. However, this is not a requirement, and the rafters 92 may have any spacing between them. That is, embodiments of the current disclosure may be configured to accommodate any rafter spacing (standard or custom spacings).

As illustrated in FIG. 2B, a drip edge 80 is attached to the top surface of the eaves 96 using, for example, roofing nails (or another suitable fastening mechanism). Drip edge 80 is the flashing that protects the edges of the roof from water damage. As known to people skilled in the art, flashing refers to thin pieces of impervious material (e.g., metal, etc.) installed to prevent the passage of water into the frame 90. As shown in FIG. 2C, a valley flashing 82 is then attached to the frame 90 using, for example, roofing screws (roofing nails, etc.). FIG. 2D illustrates a portion of the valley flashing 82. As best seen in FIG. 2D, valley flashing 82 incudes a crimp 86 down the center and a pair of raised supports 84 on either side of the crimp 86 to keep fast-flowing rainwater (called “cross-wash”) from flowing across the valley and up beneath the roof-covering material on the adjacent slope. Although not a requirement, in some embodiments, the supports 84 project upwards from the base of the valley flashing 82 by about an inch. The supports 84 also provide rigidity to the valley flashing 82 and assist in supporting the battens 60 (described later) of the frame 90.

With reference to FIG. 2E, inner edge flashings 88 are attached to the outer-most rafters 92 using, for example, roofing screws, nails, or another suitable attachment mechanism. Inner edge flashing 88 may have a C-shaped cross-sectional shape and may be positioned such it defines a C-shaped channel 89 (with an opening facing the roof) that extends from the eaves 96 to the ridge beam 94. As illustrated in FIG. 2F, a ridge support cap 70 may then be attached to ridge beam 94. FIG. 2G illustrates an enlarged view of a portion of the ridge support cap 70. Ridge support cap 70 is a flashing that extends along the length of the ridge beam 94 and is bent on either side of the ridge beam 94 to accommodate different slopes of the roof on either side. FIG. 2H illustrates a view of the ridge support cap 70 at an end where it interfaces with the inner edge flashing 88. As illustrated in FIG. 2H, the ridge support cap 70 may be positioned such that a portion of the cap 70 rests within the open C-channel defined by the edge flashing 88.

With reference to FIG. 2I, battens 60 that extend horizontally along the roof are then attached to the rafters 92 at a fixed spacing. The spacing between the battens 60 may depend upon the application (for example, on the size of the solar panels that will be used on the roof) and, in some cases, local building codes or specifications. The battens 60 serve as fixing points for the roofing materials above. FIG. 2J illustrates an enlarged view of a batten 60 showing its cross-sectional shape. With reference to this figure, batten 60 has a generally U-shaped cross-sectional shape with hook-like features formed on either side. As can be seen in FIG. 2I, batten 60 is attached to the roof such that an open channel (with hooks formed on either side of the channel) extends horizontally along the length of the roof. The hooks of batten 60 include a ridge-side hook 62 formed on the side of the batten 60 closer to the ridge beam 94 and an eave-side hook 64 formed on the side of the batten 60 closer to the eaves 96. One end of the batten 60 is positioned within the open C-channel defined by the edge flashing 88 and its opposite end is positioned proximate to a raised support 84 of valley flashing 82 (see FIG. 2K).

With reference to FIG. 2L, an eave cap 66 is then attached to the drip edge 80 on top of the eaves 96. Similar to batten 60, one end of the eave cap 66 (proximate the edge flashing 88) is positioned within the channel of edge flashing 88 and its opposite end is positioned proximate to the raised support 84 of the valley flashing 82. The solar panels 10, filler panels 20, and ridge panels 30 (and other roofing materials) may then be attached to the roof frame 90. In some embodiments, an insulating material (e.g., pads of an insulating material) may be attached to the frame 90, and the panels attached atop the insulating pads. In some embodiments, a plastic or polymer sheet (e.g., a water-proof sheet, a fire proof sheet (such as, for example, Atlas FR-10 or GAF Versashield), etc.) may be laid out on the frame 90 and the solar, filler, and ridge panels 10, 20, 30 attached on top of the sheet. It is also contemplated that, in some embodiments, conventional sheathing (plywood, Oriented Strand Board (OSB), etc.) may be attached to the frame 90, and the panels 10, 20, 30 attached atop the sheathing. In some embodiments, the solar, filler, and ridge panels 10, 20, 30 may be directly attached to the frame 90 (i.e., without a plastic/polymer sheet or a board (e.g., OSB) etc.). The configuration of an exemplary solar, filler, and ridge panel 10, 20, 30 will now be described.

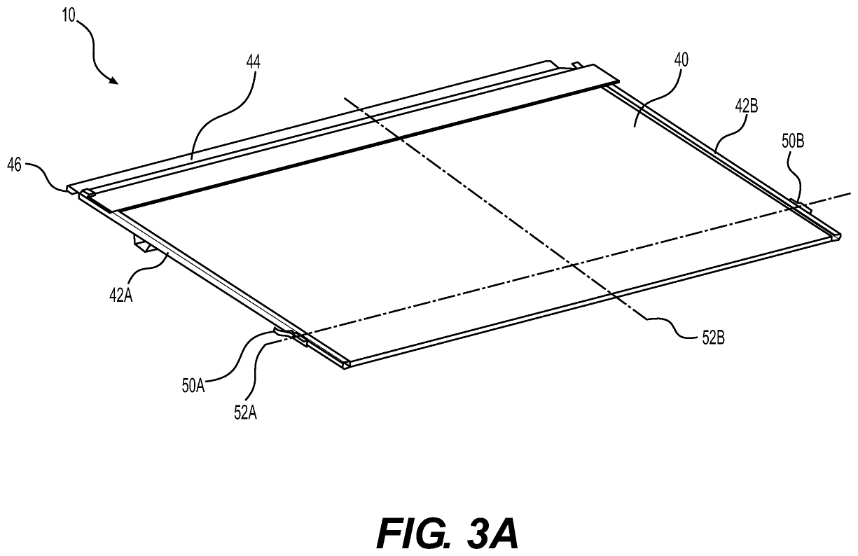

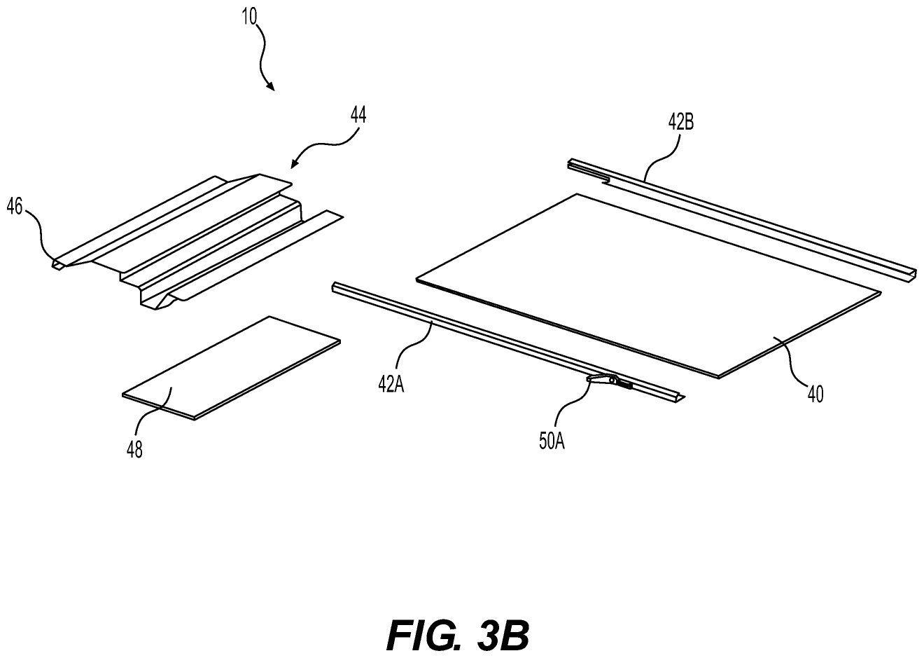

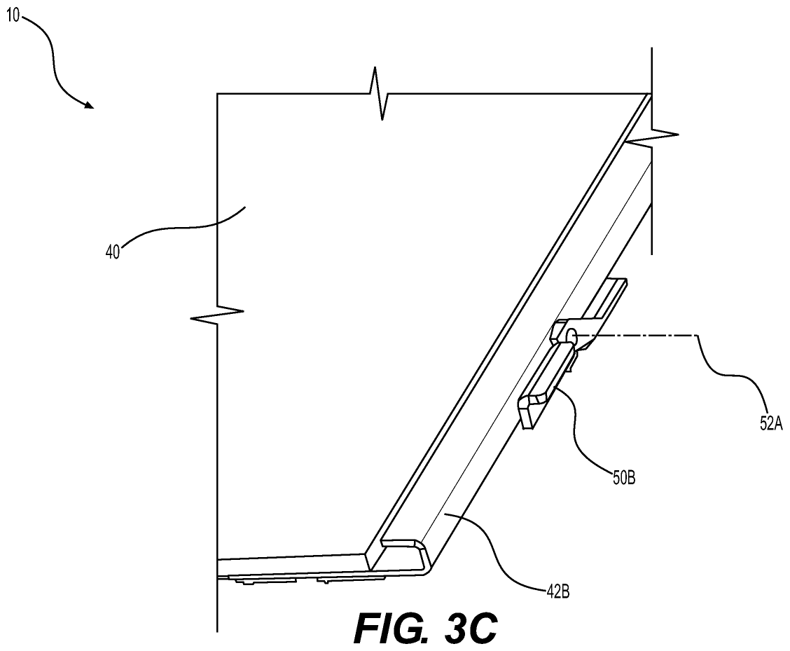

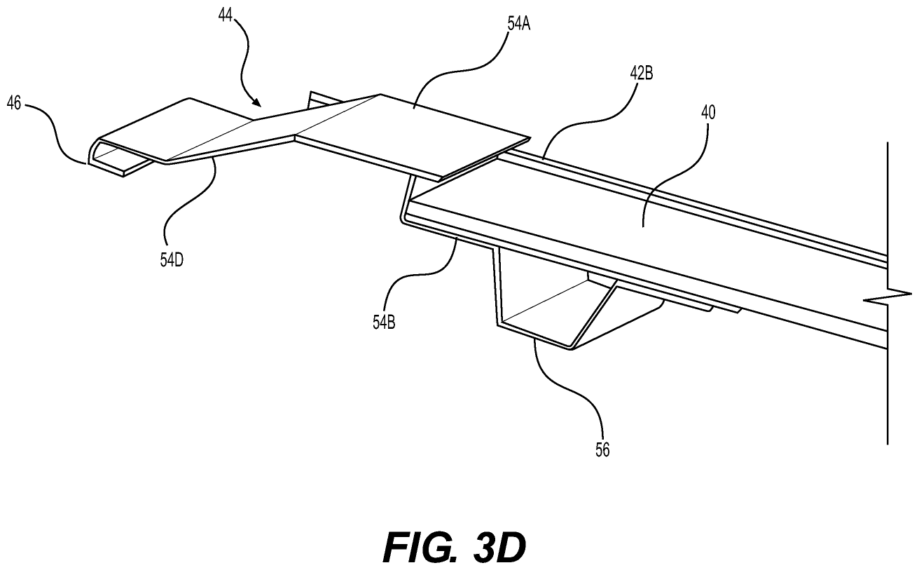

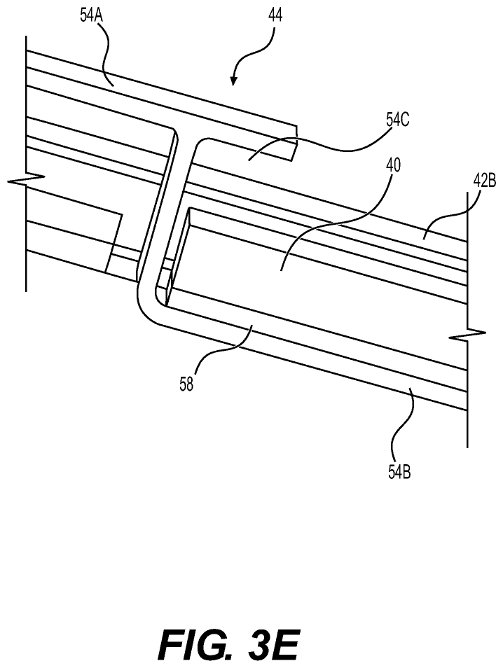

FIGS. 3A and 3B illustrate an exemplary solar panel 10 that may be attached to the roof frame 90. FIG. 3A illustrates an assembled view of the solar panel 10 and FIG. 3B illustrates an exploded view showing its constituent parts. Solar panel 10 includes a photovoltaic (PV) plate 40, a pair of side supports 42A, 42B, and a top support 44. Among other constituent components, PV plate 40 includes an array of solar cells that convert sunlight into electricity. Without limitation, any type of commercially available or custom fabricated solar cell array may be used as PV plate 40. Although not a requirement, in some embodiments, PV panel 40 includes a photovoltaic layer (with a solar cell array) with tempered glass layers or panels on either side. In some embodiments, the PV panel 40 may include a protective glass layer on one side and a polymeric back sheet on the opposite side. In some embodiments, the solar panel 10 may be positioned on the frame 90 such that the tempered glass layers of the PV plate 40 form the outer and inner surfaces of the solar panel 10. Recall that, outer surface refers to the surface facing the sky, and inner surface refers to the surface facing the inside of the building. It should be emphasized that PV panel 40 may include (or incorporate) a custom made or any commercially available solar panel (e.g., First Solar Series 4™ PV module, SunPower X series, REC Alpha Series, Panasonic 340N HIT, Solaria Power XT, etc.).

The side supports 42A and 42B may be attached to opposite sides (or edges) of the PV panel 40 and may extend substantially over the entire length of the PV panel 40. It should be noted that, although each side support 42A, 42B is illustrated as being a single component (or piece), this is only exemplary. In some embodiments, multiple smaller lengths of the support may be positioned end-to-end to form each side support 42A, 42B. The side supports 42A, 42B may be formed of any material and may be attached to the PV panel 40 in any manner. In some embodiments, the side supports 42A, 42B may be formed of a rust-resistant material, such as, for example, steel, aluminum, etc. In some embodiments, an adhesive may be used to attach the side supports 42A, 42B to the PV panel 40. As best seen in FIG. 3A, side supports 42A, 42B are positioned in a mirror-symmetric manner about a central axis 52B of the solar panel 10. As best seen in FIG. 3C, in some embodiments, one side (e.g., the back side or the inside surface) of the PV panel 40 rests on, and is attached to, a ledge formed on each side support 42A, 42B. In some embodiments, each side support 42A, 42B includes a pivoted latch 50A, 50B that is configured to rotate on the respective side support about an axis 52A that extends substantially parallel to a surface (outer and/or inner surface) of the PV panel 40. As will be explained later, in the exemplary embodiment of the solar panels 10 described herein, the latches 50A, 50B are used to attach the bottom end of the solar panel 10 to the battens 60 of the roof frame 90. As explained previously, bottom end of the solar panel 10 refers to the end of the solar panel closer to the eaves 96, and the top end of the solar panel 10 refers to the end of the solar panel closer to the ridge beam 94 (when the solar panel 10 is attached to the frame 90).

It should be noted that latches 50A, 50B are not a requirement. In some embodiments, in place of latches 50A, 50B (or in addition to the latches), the side supports 42A, 42B may include other locking features (e.g., sliding locks, spring loaded latches, threaded fasteners, over-center latches, cam features, tension clips, etc.) that may be used to fix the bottom end of the solar panel 10 to the battens 60. It should be noted that the specific structure of the side supports 42A, 42B described herein is only exemplary. In some embodiments, the side supports 42A, 42B may have other configurations suited to support the specific locking features provided thereon.

The top support 44 is attached to the top side (or edge) of the PV panel 40 between the side supports 42A, 42B. Although not a requirement, in some embodiments, the top support 44 may also be formed of the same material as the side supports 42A, 42B. Similar to the side supports 42A, 42B, in some embodiments, multiple lengths of support may be positioned end-to end to form the top support 44. At its top end (i.e., the end located closer to the ridge), the top support 44 includes a hook 46 or a hanger that extends substantially along an entire length of the PV panel 40. As will be explained later, in the exemplary embodiment of the solar panels 10 described herein, the hook 46 is used to attach (or hang) the top end of the solar panel 10 to the battens 60 of the roof frame 90.

With reference to FIGS. 3D and 3E, top support 44 includes a top plate 54A and a bottom plate 54B that are connected together and vertically spaced apart from each other to have a step-like configuration. As best seen in FIG. 3E, the bottom end of the top plate 54A (i.e., the end located closer to the eaves) overhangs the top end of the bottom plate 54B (i.e., the end located closer to the ridge beam) to form a C-shaped recess 54C therebetween. The top end of the PV panel 40 is positioned in the recess 54C such that the overhanging portion of the top plate 54A extends over the top end of the PV panel 40. The overhanging portion of the top plate 54A reduces (or prevents) ingress of rainwater (wind, etc.) between the top support 44 and the PV panel 40. It is contemplated that, in some embodiments, the top plate 54A of top support 44 may not include an overhanging portion. That is, in some embodiments, the top plate 54A and bottom plate 54B may form a step-like ledge with the top end of the PV panel 40 placed on the ledge. The PV panel 40 may be attached to the top support 44 using an adhesive. Any type of adhesive may be used to attach the PV panel 40 to the top support 44. In some embodiments, as best seen in FIG. 3E, a portion of the inner surface of the PV panel 40 (i.e., the surface facing the inside of the building) is attached to the outer surface of the bottom plate 54B (i.e., the surface facing the sky) using, for example, an adhesive. In some embodiments, as shown in FIG. 3E, a support plate 58 may be positioned between the PV panel 40 and the bottom plate 54B. Support plate 58 may be formed of any material (metal, plastic, etc.) and may have any configuration. In some embodiments, the support plate 58 may be eliminated.

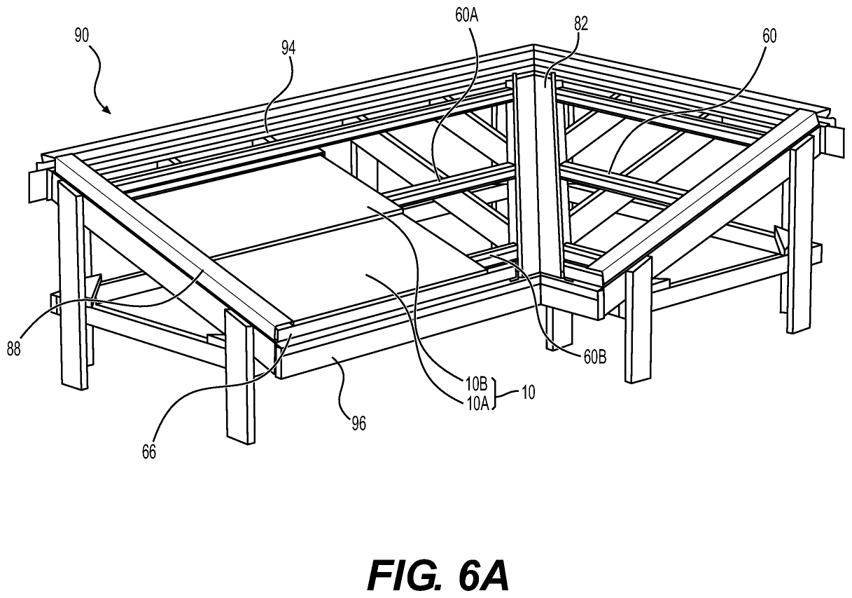

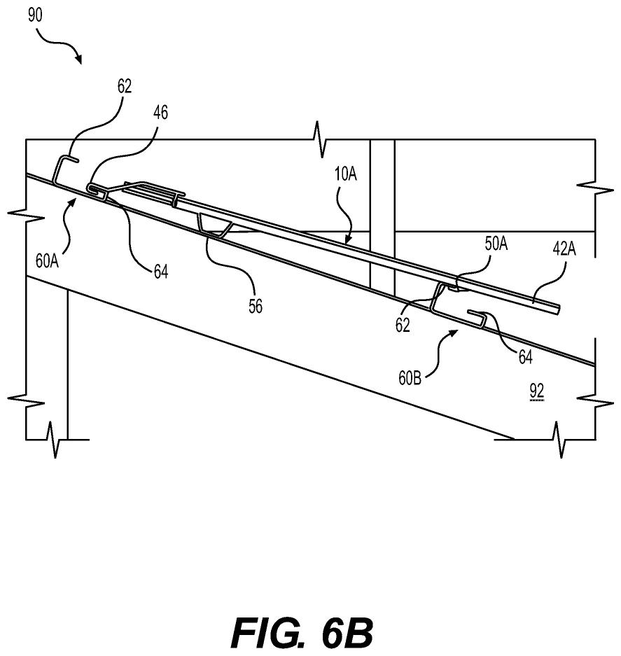

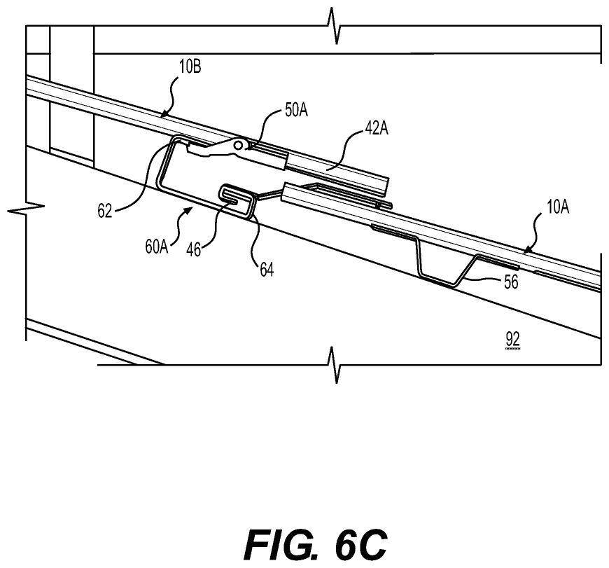

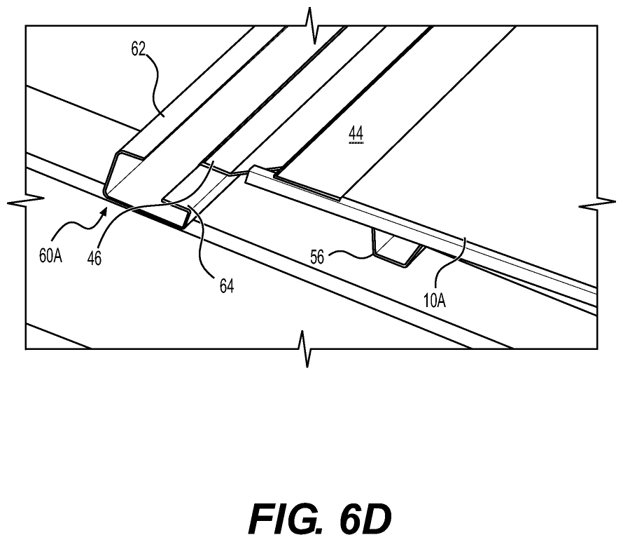

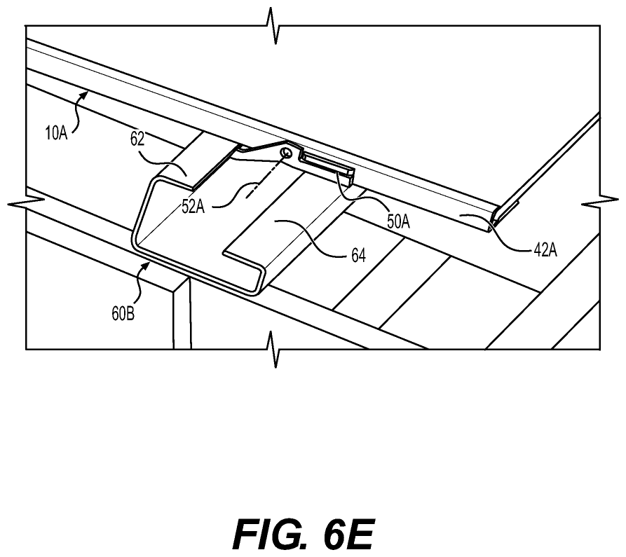

As best seen in FIG. 3D, a portion of the bottom plate 54B below the PV panel 40 may be bent to form a substantially trapezoidal (rectangular, square, etc.) standoff 56 that projects away from the PV panel 40. In some embodiments, the standoff 56 may extend substantially the entire length of the bottom plate 54B. The top plate 54A includes a sloping region 54D between its overhanging bottom end and the top end with the hook 46. The sloping region 54D slopes downwards as it extends towards the top end such that the hook 46 is positioned below the outer surface of the PV panel 40 (see FIGS. 6B and 6C). In some embodiments, the slope of the sloping region 54D may be such that the hook 46 is positioned below the inner surface of the PV panel 40. The hook 46 may be formed by a region of the top end of the top plate 54A that is bent inwards to form a curved region. As will be explained later, the hook 46 is used to attach (or hook) the top end of the solar panel 10 to the battens 60 of the roof frame 90. When the hook 46 is attached to a batten 60, the standoff 56 rests on the rafters 92, and the PV panel 40 is spaced apart from the rafters 92 (see FIGS. 6B and 6C).

It should be noted that although a hook 46 is described as being used to attach the top end of the solar panel 10 to the frame 10, this is only exemplary. In some embodiments, in place of the hook 46 (or in addition to the hook), the top support 44 may include other fastening mechanisms (threaded fasteners, clips, latches, etc.) that may be used to attach the top end of the solar panel 10 to the battens 60. It should be noted that the specific structure of the top support 44 described herein is only exemplary, and in some embodiments, the top support may have other configurations better suited to support the specific fastening mechanisms provided in the top support.

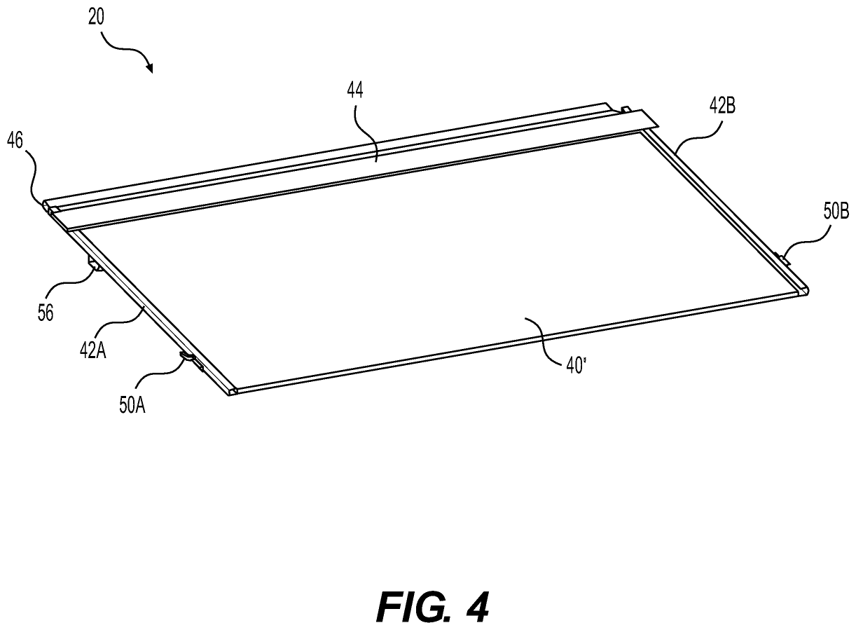

FIG. 4 illustrates an exemplary filler panel 20. Filler panel 20 includes a roofing board 40″, a pair of side supports 42A, 42B, and a top support 44. In general, filler panel 20 is similar in configuration and structure to the solar panel 10, except that the PV panel 40 of solar panel 10 is replaced with the roofing board 40″ in filler panel 20. Unlike the PV panel 40, roofing board 40″ does not include solar cells. Instead, roofing board 40″ may include a board or a panel made of any suitable material and have substantially the same thickness as PV panel 40. In some embodiments, the roofing board 40″ may include plywood, particle board, steel, aluminum, fiberglass, plastic, composite plastics, oriented strand board and/or other conventional roofing materials with or without an acrylic or polymer film for aesthetics and weather performance. In some embodiments the roofing board 40″ may be made of a polymer or acrylic sheet. In some embodiments, the roofing board 40″ may be similar in appearance to the PV panel 40. For example, roofing board 40″ may include conventional roofing materials coated with one or more materials to resemble the PV panel 40 (in color, reflectivity, etc.) such that, when the roof is viewed from the ground, the filler panel 20 looks similar to the solar panel 10. Since the side supports 42A, 42B and top support 44 of filler panel 20 and solar panel 10 are substantially similar in structure, and they are attached to the filler panel 20 in a similar manner, they will not be described again. The description of these components made with reference to the solar panel 10 is equally applicable with reference to the filler panel 20.

The absence of solar cells (that are typically formed on a relatively brittle semiconductor material) in the filler panel 20 enables the filler panel 20 to be cut into any desired shape. With reference to FIG. 1, the filler panel 20 is normally applied to non-rectangular shaped regions of the roof (e.g., adjacent to the valley flashing 82, at locations where components may penetrate the roof (such as, for example, chimneys, vents, etc.) where a solar panel 10 cannot be applied due to the shape mismatch. The ability to cut the filler panel 20 enables it to be cut to the shape of the roof area that cannot be covered by the solar panel 10.

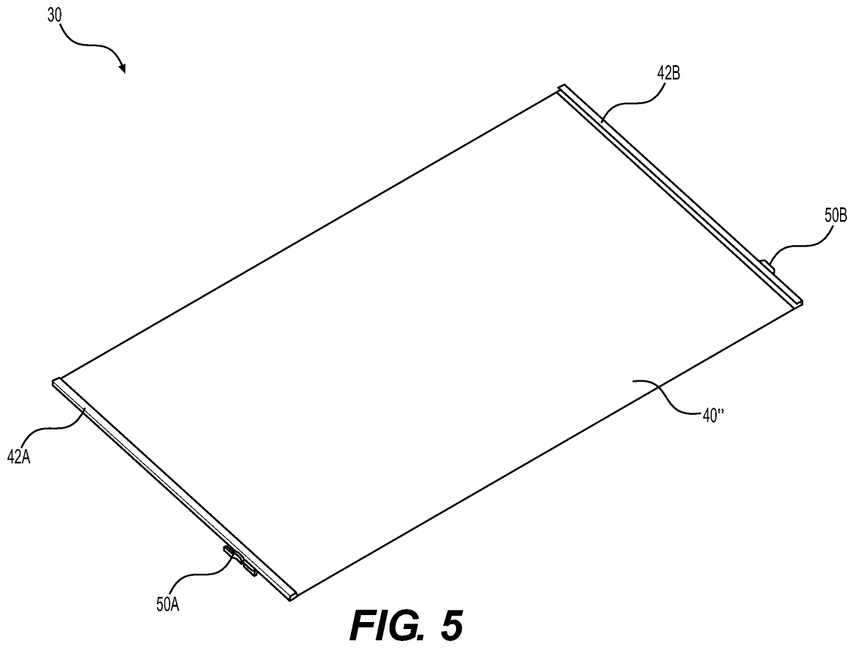

FIG. 5 illustrates an exemplary ridge panel 30. Ridge panel 30 includes a roofing board 40″ and a pair of side supports 42A, 42B attached to opposite sides of the roofing board 40″. Similar to roofing board 40″ of the filler panel 20, roofing board 40″ of ridge panel 30 does not include solar cells. Instead, roofing board 40″ may include a panel made of any suitable material, have substantially the same thickness as PV panel 40, and may resemble the PV panel 40 in appearance. In some embodiments, roofing board 40″ may include conventional roofing materials coated with one or more materials to resemble the PV panel 40 (in color, reflectivity, etc.) such that, when the roof is viewed from the ground, the ridge panel 30 (and the filler panel 20) looks similar to the solar panel 10. In some embodiments, roofing board 40″ of the filler panel 20 and roofing board 40″ of ridge panel 30 may include the same material. The ridge panel 30 may be similar in configuration to the solar panel 10 and the filler panel 20 except that the ridge panel 30 does not include a top support 44. Similar to the side supports 42A, 42B of the solar panel 10, each of the side supports 42A, 42B of the filler and ridge panels 20, 30 may also include a latch 50A, 50B configured to lock (or attach) the bottom ends of the respective panels to the battens 60 of the roof frame 90.

Since the side supports 42A, 42B of the ridge panel 30 (and the filler panel 20) are substantially similar to the side supports of the solar panel 10 (and are attached to the ridge panel 30 in a similar manner), they will not be described again. The description of the side supports 42A, 42B and their latches 50A, 50B made with reference to the solar panel 10 is equally applicable with reference to the side supports and latches of the ridge panel 30 (and the filler panel 20). As described with reference to the solar panel 10, in some embodiments, in place of latches 50A, 50B (or in addition to the latches), the side supports 42A, 42B of the filler and ridge panels 20, 30 may include other locking features that may be used to fix the bottom ends of these panels to the battens 60. Similar to the filler panel 20, the absence of solar cells in the ridge panel 30 also enables the ridge panel to be cut (e.g., to reduce its length). With reference to FIG. 1, the ridge panel 30 is normally applied to regions adjacent to the ridge of the roof which, in some cases, may have a length smaller than the length of a solar panel 10. The ability to cut the ridge panel 30 enables it to be used to cover the roof area near the ridge that cannot be covered with a solar panel 10.

An exemplary method of forming the solar roof 100 (see FIG. 1) on frame 90 (of FIG. 2L) using the above-described solar, filler, and ridge panels 10, 20, 30 will now be described. For the sake of brevity, conventional steps and techniques related to forming the roof may not be described in detail herein. Solar panels 10 may first be installed on the frame 90. FIG. 6A illustrates two solar panels 10 (which will be described as solar panels 10A and 10B) installed on the frame 90. With reference to this figure, in some embodiments, installation of the solar panels may begin at a side of the roof near the eaves 96 and continue up towards the ridge beam 94. That is, in some embodiments, solar panel 10A may be installed first and solar panel 10B may then be installed. Additional solar panels 10 may then be installed adjacent to the initially installed solar panels 10A, 10B towards the valley flashing 82 (if there is sufficient space to accommodate a solar panel 10).

FIG. 6B is a cross-sectional view of the first solar panel 10A (of FIG. 6A) attached to first and second battens 60A, 60B of frame 90. With reference to FIG. 6B, to attach solar panel 10A to the frame 90, the hook 46 on the top support 44 of solar panel 10A is engaged with (or hung on) the eave-side hook 64 of a first batten 60A (see FIG. 6D), and the latches 50A, 50B on the side supports 42A, 42B of solar panel 10A are engaged with the ridge-side hook 62 of a second batten 60B that is adjacent to and below the first batten 60A (see FIG. 6E). The latches 50A, 50B may be engaged with the ridge-side hook 62 by rotating the latches 50A, 50B about axis 52A to lock the arms of the latches 50A, 50B on the ridge-side hook 62. With reference to FIG. 6B, in some embodiments, the solar panel 10A may first be rotated in a counterclockwise direction to engage its hook 46 with the eave-side hook 64 of the first batten 60A. The solar panel 10A may then be rotated in the clockwise direction to engage the latches 50A, 50B with the ridge-side hook 62 of the second batten 60B. In some embodiments, as illustrated in FIG. 6B, when solar panel 10A is coupled to the battens 60A, 60B, the standoff 56 of the solar panel 10A may rest on (and be supported by) the rafters 92 extending between the ridge beam 94 and the eaves 96.

As would be recognized by people skilled in the art, in embodiments where a different attachment mechanism is used in place of the latches 50A, 50B, the attachment mechanism may be locked on the ridge-side hook 62 (or another part of the second batten 60B) by a different method. For example, in embodiments where a biased spring-loaded member is used as the attachment mechanism, the spring-loaded member may be manipulated to engage with the ridge-side hook 62. Similarly, in embodiments where a threaded fastener is used as the attachment mechanism, the threaded fastener may be fastened on the second batten 60B. And, in embodiments where a slider arm is used as the attachment mechanism, the slider arm may be slid into engagement with the second batten 60B.

Referring again to FIG. 6A, after the first solar panel 10A is attached to the frame 90, the second solar panel 10B is attached to the frame 90 towards the ridge beam 94 in a similar manner. That is, the hook 46 of solar panel 10B is engaged with the eave-side hook 64 of a batten 60 immediately above the first batten 60A and the latches 50A, 50B of solar panel 10B are engaged with the ridge-side hook 62 of the first batten 60A. FIG. 6C is a cross-sectional view showing the top portion of the first solar panel 10A and the bottom portion of the second solar panel 10B. As can be seen in this figure, when solar panels 10A and 10B are attached, a portion of the bottom end of solar panel 10B overlaps a portion of the top end of the first solar panel 10A. This overlap may prevent (or reduce) rainwater from seeping through the gap between the solar panels 10A, 10B. In some embodiments, a gap-filler material (waterproof material, insulating material, etc.) may be provided in this gap to further reduce rainwater seepage.

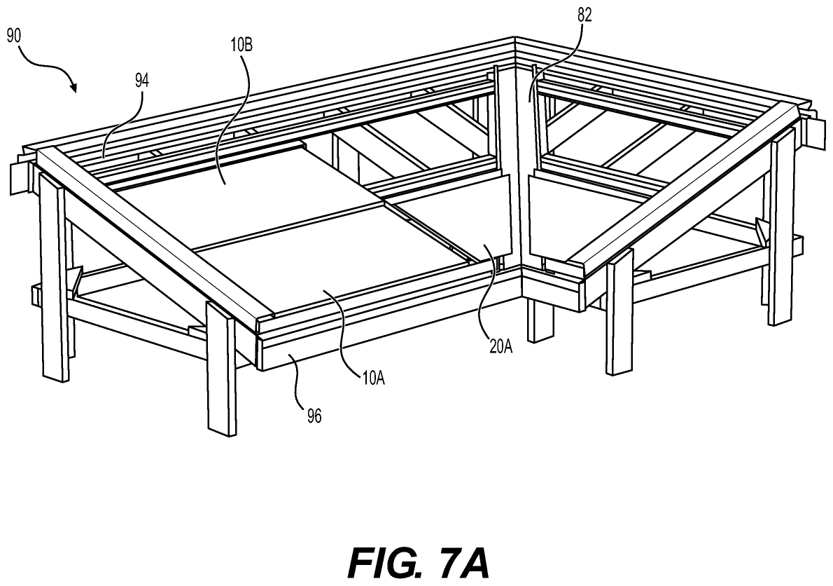

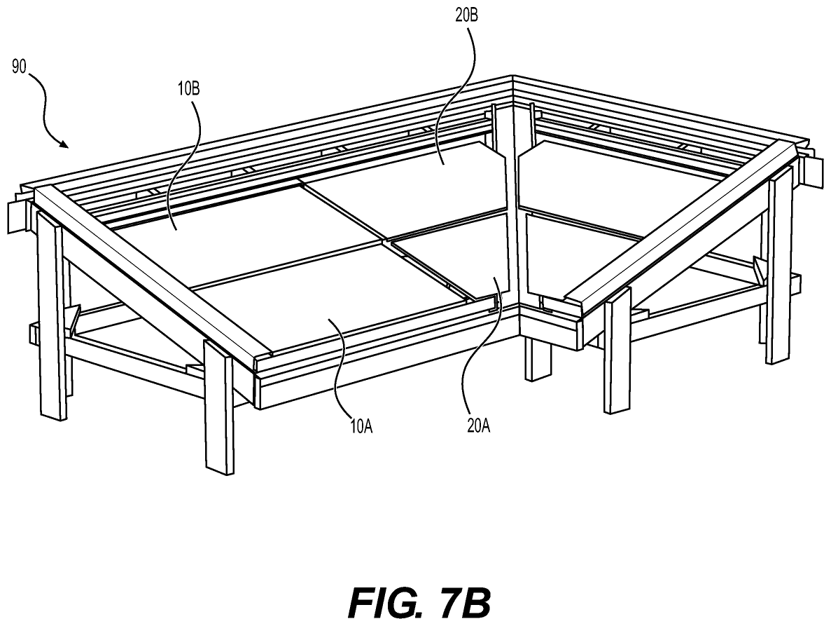

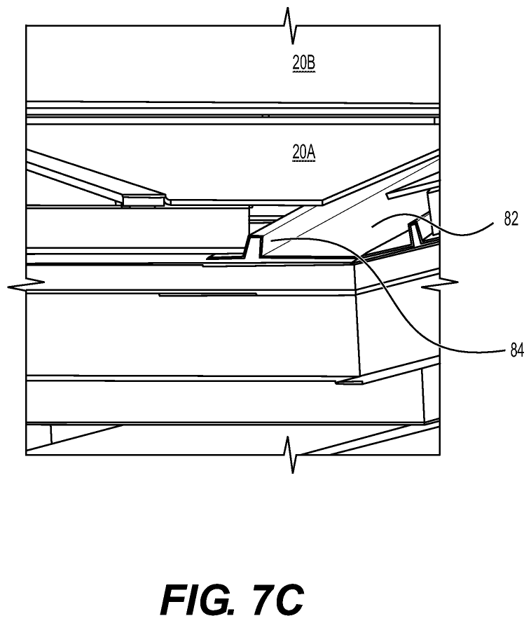

The filler panels 20 may then be attached to the frame 90. FIG. 7A shows a first filler panel 20A attached to the frame 90 adjacent to solar panel 10A, and FIG. 7B shows a second filler panel 20B attached to the frame 90 adjacent to solar panel 10B. In some embodiments, similar to the solar panels 10, filler panels 20 close to the eaves 96 may be installed first and the filler panels 20 close to the ridge beam 94 may then be installed. That is, first filler panel 20A may be installed before second filler panel 20B is installed. The filler panels 20A, 20B may also be installed in a similar manner as the solar panels 10A, 10B. That is, to attach the first filler panel 20A to the frame 90 adjacent to solar panel 10A, the hook 46 on the top support 44 of the first filler panel 20A is engaged with the eave-side hook 64 of the first batten 60A (see FIG. 6D), and the latches 50A, 50B on the side supports 42A, 42B of the filler panel 20A are engaged with the ridge-side hook 62 of the second batten 60B (see FIG. 6E) below the first batten 60A. In some embodiments, as can be seen in FIGS. 7A and 7B, filler panels 20A and 20B may be cut to fill the available space between solar panels 10A, 10B and the valley flashing 82. Cutting filler panel 20A (or 20B) may partially or completely remove the right-side support 42B and its latch 50B from the filler panel 20A. In such cases, the bottom end of the filler panel 20 may be attached to a batten 60 by only one latch.

For example, to attach filler panel 20A of FIG. 7A to the first and second battens 60A, 60B, the hook 46 of filler panel 20A is engaged with the eave-side hook 64 of the first batten 60A and latch 50A on the left support 42A of the filler panel 20A is engaged with the ridge-side hook 62 of the second batten 60B. Filler panel 20B is then attached to the frame 90 in a similar manner. After attachment of the first and second filler panels 20A, 20B, similar to that seen in FIG. 6C, a portion of the bottom end of second filler panel 20B overlaps a portion of the top end of the first filler panel 20A to minimize seepage of rainwater through the gap between them. In some embodiments, a gap-filler material (waterproof material, insulating material, etc.) may be provided in this gap to further reduce rainwater seepage. As illustrated in FIG. 7C, the cut edge of these filler panels 20A, 20B may extend over a raised support 84 of the valley flashing 82 to minimize rainwater runoff from passing beneath the filler panels 20A, 20B. In some embodiments, the gap-filler material may also be provided in this gap.

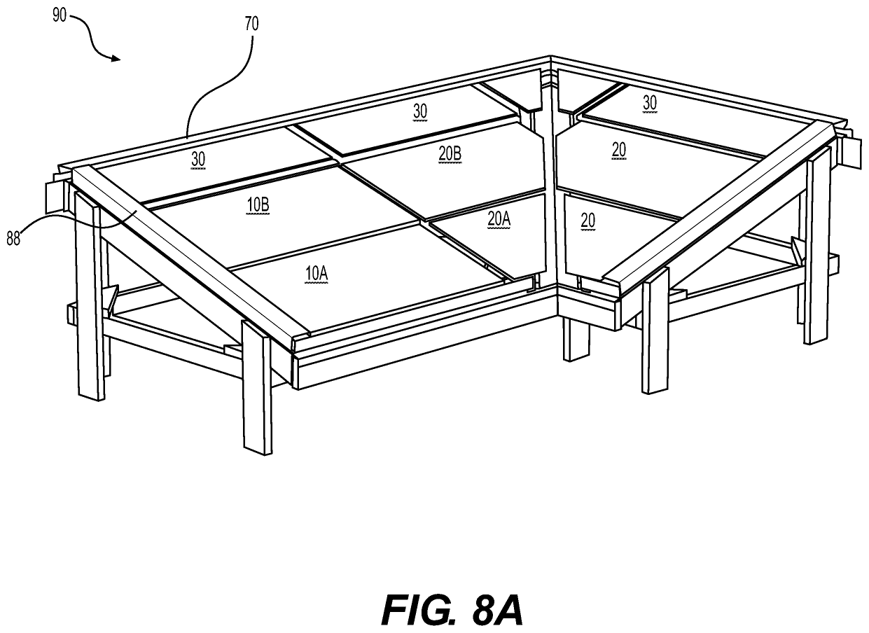

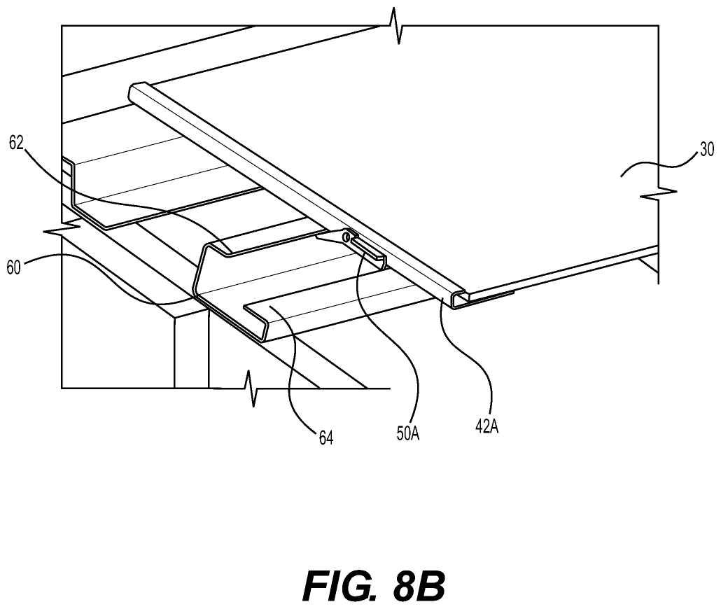

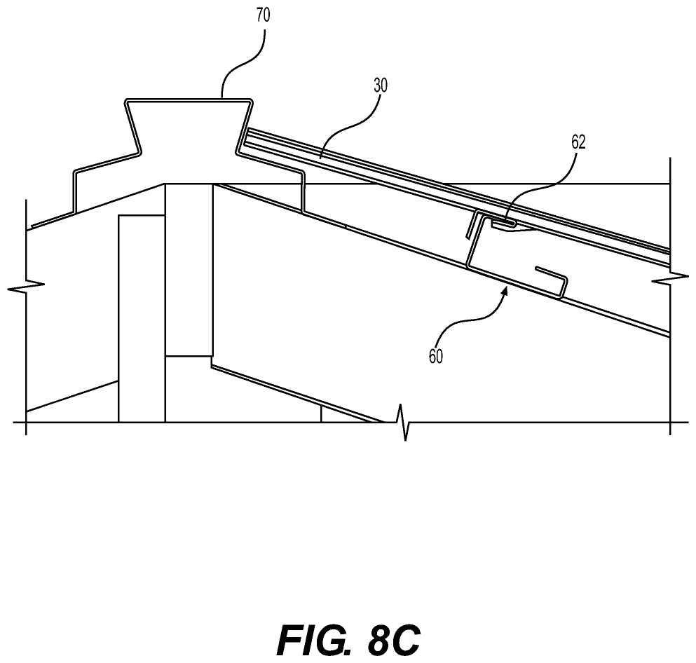

The ridge panels 30 may now be attached to the frame proximate the ridge beam 94. FIG. 8A illustrates the ridge panels 30 attached to the frame 90. As explained with reference to FIG. 5, unlike the solar and filler panels 10, 20, the ridge panels 30 do not include a top support with a hook. The ridge panels 30 are attached to the battens 60 of the frame 90 using only the latches 50A, 50B of its side supports 41A, 42B. FIGS. 8B and 8C illustrate the attachment of a ridge panel 30 to the frame 90. With reference to these figures, the latches 50A, 50B of ridge panel 30 engage with a ridge-side hook 62 of a batten 60. When a ridge panel 30 is attached above solar panel 10B (described with reference to FIGS. 6A-6C), the latches 50A, 50B of the ridge panel 30 engage with the ridge-side hook 62 of the same batten 60 that the hook 46 of solar panel 10B (i.e., the solar panel below) engages with. And, similar to that described with reference to FIG. 6C, a portion of the bottom end of the ridge panel 30 overlaps a portion of the top end of the solar panel 10B to form an overlapping region. As can be seen in FIGS. 8B and 8C, the top end of the ridge panel 30 extends over a portion of the ridge support cap 70 (attached on the ridge beam 94, see FIG. 2F) to create an overlapping region. In some embodiments, a gap-filler (waterproof material, insulating material, etc.) may be placed in the overlapping between the ridge panels 30 and ridge support cap 70.

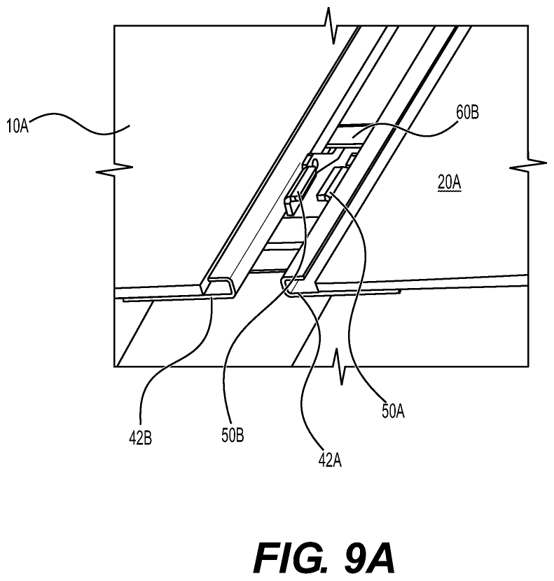

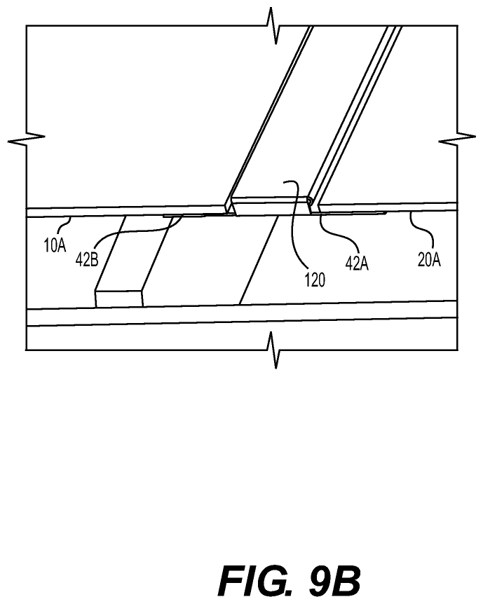

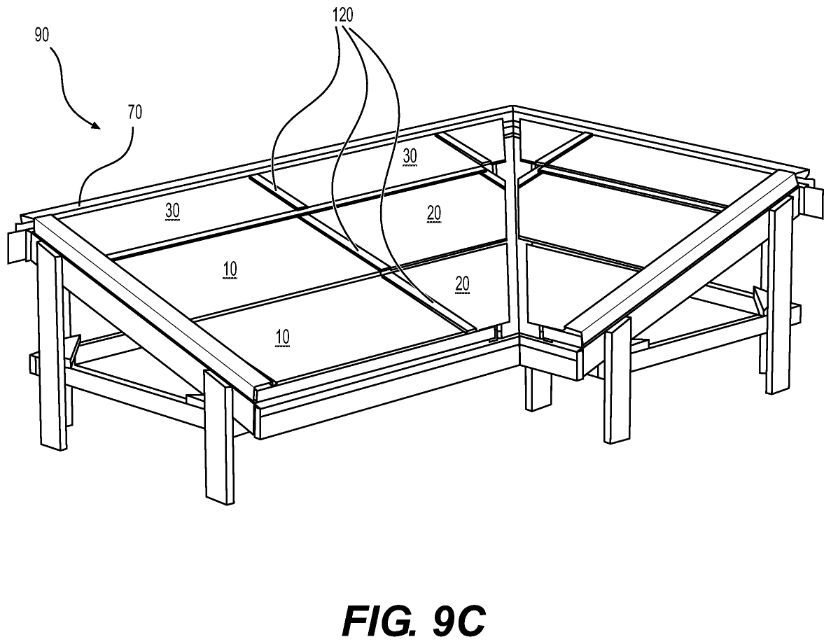

Adjacently positioned panels 10, 20, 30 are attached to the frame 90 side-by-side on the same two battens 60. For example, solar panel 10A and filler panel 20A are attached to the frame 90 on the first and second battens 60A, 60B (of FIG. 6B). FIGS. 9A and 9B illustrate a portion of the adjacently positioned solar and filler panels 10A, 20A. As shown in FIG. 9A, these panels 10A, 20A are attached such that they are spaced apart from each other. After attachment of the adjacently positioned solar and filler panels 10A, 20B, a support cap 120 may be engaged with the adjacently positioned right-side support 42B of solar panel 10A and left-side support 42A of filler panel 20A to fix (or lock) the spacing between the solar and filler panels 10A, 20A. The support cap 120 may be a cover piece with feet that slides into the channels formed by the oppositely facing substantially C-shaped side supports 42A, 42B to lock the spacing between the adjacent solar and filler panels 10, 20. Since the support cap 120 covers and extends over the latches 50A, 50B (i.e., latch 50B of solar panel 10A and latch 50A of filler panel 20A in FIG. 9A), it prevents these latches from opening (e.g., accidentally). Similar support caps 120 may be installed between all adjacently positioned panels 10, 20, 30 to fix the spacing between these panels and keep their latches in a locked position.

FIG. 9C illustrates the frame 90 with support caps 120 installed between adjacently positioned panels 10, 20, 30. To remove a panel from the frame 90, the support caps 120 on either side of the panel are first removed to enable their latches to be released. For example, with reference to FIGS. 6A-6E, to remove solar panel 10A from the frame 90 (e.g., for repair), support caps 120 from either side of solar panel 10A are first removed, and the latches 50A, 50B of the solar panel 10A are rotated (about axis 82A) to an unlocked position. In the unlocked position, the latches 50A, 50B are disengaged from the ridge-side hook 62 of the second batten 60B (see FIG. 6E). The hook 46 on the top support 44 of solar panel 10A is then disengaged (or unhooked) from the eave-side hook 64 of the first batten 60A (see FIG. 6D), and the solar panel 10A is lifted off the frame 90. After repairs, the solar panel 10A may be reinstalled and the cover caps 120 on either side of the solar panel 10A inserted.

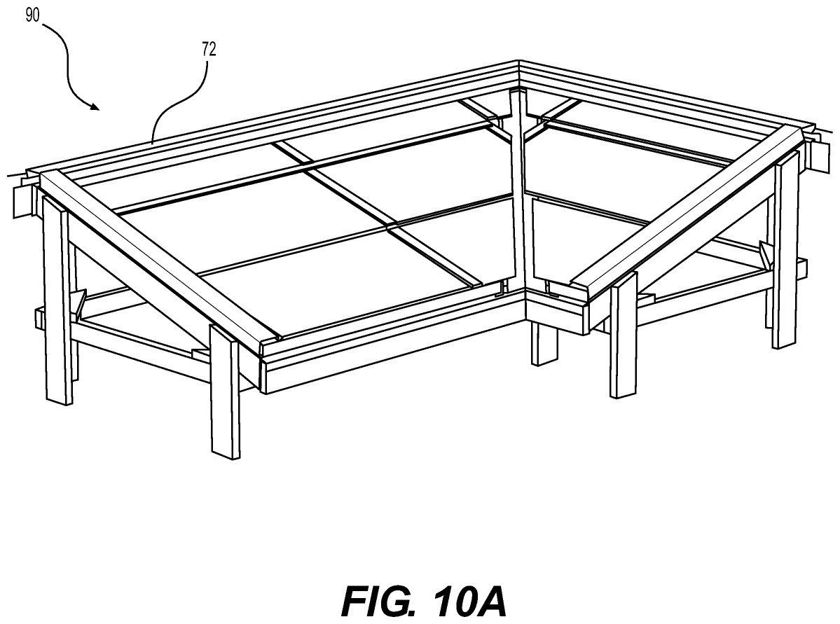

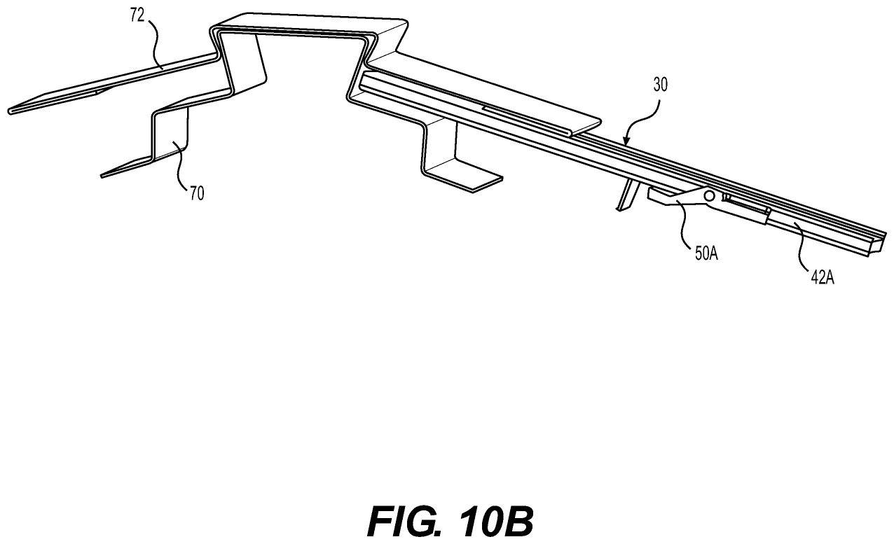

With reference to FIGS. 10A and 10B, after the support caps 120 are installed, a ridge cap 72 is attached over the ridge support cap 70 on the ridge of the roof. Similar to the ridge support cap 70, ridge cap 72 is a flashing that extends along the length of the ridge beam 94 and is bent on either side of the ridge beam 94 to accommodate different slopes of the roof on either side. As best seen in FIG. 10B, a portion of the ridge cap 72 extends over, and overlaps with, the overlapping region of the ridge panel 10 and the ridge support cap 70 to prevent rainwater from seeping between them. In some embodiments, a gap-filler (waterproof material, insulating material, etc.) may be placed between the overlapping portion of the ridge cap 72 and the ridge support cap 70. In some embodiments, the ridge cap 72 may incorporate ventilation features.

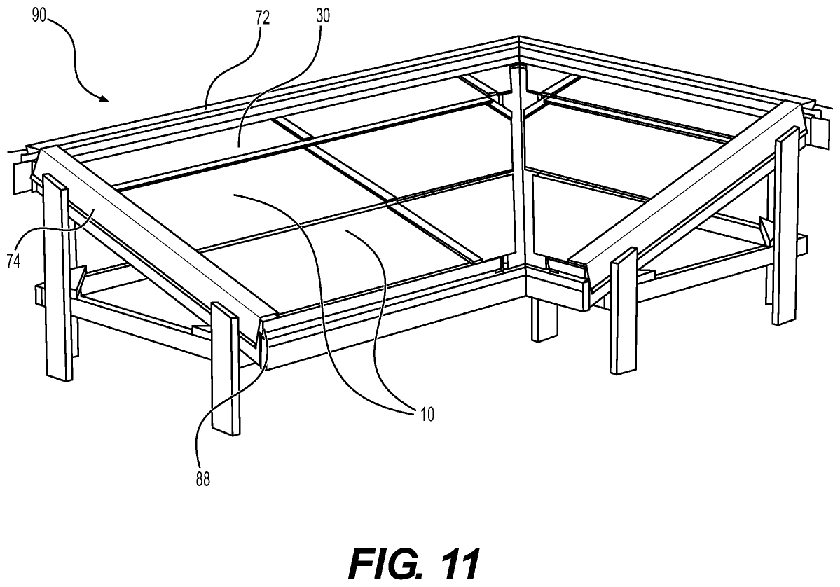

As illustrated in FIG. 11, an edge cap 74 may also be placed over the inner edge flashing 88 on the side edges of the roof to reduce water ingress. In some embodiments, the edge cap 74 may be an L-shaped flashing that extends along the side of the roof from the eaves 96 to the ridge beam 94. In some embodiments, a portion of the edge cap 74 may overlap with side portions of the solar and ridge panels 10, 30 to minimize infiltration of water therethrough.

In some embodiments of the disclosed solar roof, the mechanical barrier is the solar panel (and filler and ridge panels) and the weather barrier is a membrane (e.g., a polymer sheet) positioned above and protected by the mechanical barrier. In some embodiments, the solar panel may serve as both the mechanical and weather barrier. That is, a separate weather barrier (e.g., polymer sheet) may be eliminated and the solar (filler and ridge) panels may incorporate weather protection features. In the disclosed solar roof, the attachment rails and the frames of the solar panels ensures that all solar panels (filler panels and ridge panels) are installed evenly. The clip system of each panel ensures that each panel is securely coupled to the roof. And the cover plate between adjacent panels ensures the clip system of the panels remains in a locked position. In some embodiments, the solar panels (filler panels and ridge panels) may be attached to the roof such that a gap formed between the panels provide ventilation.

It should be appreciated that the above-described method of forming the solar roof may include any number of additional or alternative steps or operations. Since these steps are well known to people skilled in the art, they have not been described. Further, although a particular order of the different steps is implied in the description above, these steps do not necessarily have to be performed in the described order. Additionally, one or more of the described steps may be omitted from an embodiment so long as the intended overall functionality remains substantially the same.

What is claimed is:

1. A solar roof of a building, comprising:
a plurality of solar panels removably coupled to a roof of the building, wherein each solar panel of the plurality of solar panels includes solar cells, and wherein a first solar panel of the plurality of solar panels is configured to be removed from the roof without removing an adjacent solar panel.

2. The solar roof of claim 1, wherein the first solar panel includes one or more locking features that is configured to removably attach the first solar panel to the roof.

3. The solar roof of claim 2, wherein the one or more locking features include a first locking feature configured to removably couple one end of the first solar panel to the roof and a second locking feature configured to removably couple an opposite end of the first solar panel to the roof.

4. The solar roof of claim 3, wherein the first locking feature is a hook.

5. The solar roof of claim 3, wherein the second locking feature is at least one of a rotatable latch, a sliding latch, a spring-loaded member, or a fastener.

6. The solar roof of claim 1, further including a filler panel coupled to the roof adjacent to the first solar panel, wherein the filler panel is similar in configuration to the first solar panel, and wherein the filler panel does not include solar cells.

7. The solar roof of claim 1, further including a polymer sheet positioned below the plurality of solar panels.

8. The solar roof of claim 1, wherein an inside surface of the plurality of solar panels are exposed to an inside of the building.

9. The solar roof of claim 1, wherein the plurality of solar panels are configured to be coupled to a roof of the building without an additional waterproofing layer below the plurality of solar panels.

10. A method of forming a solar roof of a building, comprising:
removably coupling a first solar panel to a roof of the building; and
removably coupling a second solar panel to the roof adjacent to the first solar panel, wherein the first and second solar panels include solar cells, and wherein the first solar panel is configured to be removed from the roof without removing the adjacent second solar panel.

11. The method of claim 10, wherein removably coupling the first solar panel includes using a first locking feature of the first solar panel to removably couple one end of the first solar panel to the roof and using a second locking feature of the first solar panel to removably couple an opposite end of the first solar panel to the roof.

12. The method of claim 11, wherein the first locking feature is a hook.

13. The method of claim 11, wherein the second locking feature is at least one of a rotatable latch, a sliding latch, a spring-loaded member, or a fastener.

14. The method of claim 10, wherein removably coupling the first solar panel includes positioning the first solar panel above a polymeric sheet positioned on the roof.

15. The method of claim 10, wherein removably coupling the first solar panel includes positioning the first solar panel such that an inside surface of the first solar panel is exposed to an inside of the building.

16. The method of claim 10, further including removably coupling a filler panel adjacent to the second solar panel, wherein the filler panel does not include solar cells.

17. The method of claim 16, wherein the filler panel is coupled to the roof between the second solar panel and a valley of the roof.

18. The method of claim 10, further including removably coupling a ridge panel between the second solar panel and a ridge of the roof, wherein the ridge panel does not include solar cells.

19. The method of claim 10, further including removably coupling a ridge panel between the second solar panel and a ridge cap positioned on a ridge of the roof, wherein the ridge cap includes ventilation features.
